(19) United States
(12) Patent Application Publication
(10) Pub. No.: US 2007/0219796 A1
(43) Pub. Date: Sep. 20, 2007

(54) Weighted likelihood ratio for pattern recognition

(75) Inventors: Chao Huang, Beijing (CN); Frank Soong, Beijing (CN); Jian-lai Zhou, Beijing (CN)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/384,781

(22) Filed: Mar. 20, 2006

(51) Int. Cl. G10L 15/28

(52) U.S. Cl. 704/255

(57) ABSTRACT

A Weighted Likelihood Ratio Hidden Markov Model is utilized for speech processing. The model emphasizes spectral peaks when comparing spectra. Probability density functions for states in the model can be developed with weights based on the comparison.

### BACKGROUND

The discussion below is merely provided for general background information and is not intended to be used as an aid in determining the scope of the claimed subject matter.

A pattern recognition system, such as a speech recognition system or a handwriting recognition system, takes an input signal and attempts to decode the signal to find a pattern represented by the signal. For example, in a speech recognition system, a speech signal (often referred to as a test signal) is received by the recognition system and is decoded to identify a string of words represented by the speech signal.

Many pattern recognition systems utilize models in which units are represented by a single tier of connected states. Using a training signal, probability distributions for occupying the states and for transitioning between states are determined for each of the units. In speech recognition, phonetic units are used. To decode a speech signal, the signal is divided into frames and each frame is transformed into a feature vector. The feature vectors are then compared to the distributions for the states to identify a most likely sequence of states that can be represented by the frames. The phonetic unit that corresponds to that sequence is then selected.

### SUMMARY

This Summary is provided to introduce some concepts in a simplified form that are further described below in the Detailed Description. This Summary is not intended to identify key features or essential features of the claimed subject matter, nor is it intended to be used as an aid in determining the scope of the claimed subject matter.

A Weighted Likelihood Ratio Hidden Markov Model is utilized for speech processing. The model emphasizes spectral peaks when comparing spectra. Probability density functions for states in the model can be developed with weights based on the comparison.

### BRIEF DESCRIPTION OF THE DRAWINGS

FIG. 1 is a block diagram of a computing environment.

FIG. 2 is a block diagram of a speech recognition system.

FIG. 3A is a graph of two power spectra.

FIG. 3B is a graph of two log power spectra.

FIG. 4 is a flow diagram of a method for deriving coefficients.

FIG. 5 is a block diagram of a system for training a model.

### DETAILED DESCRIPTION

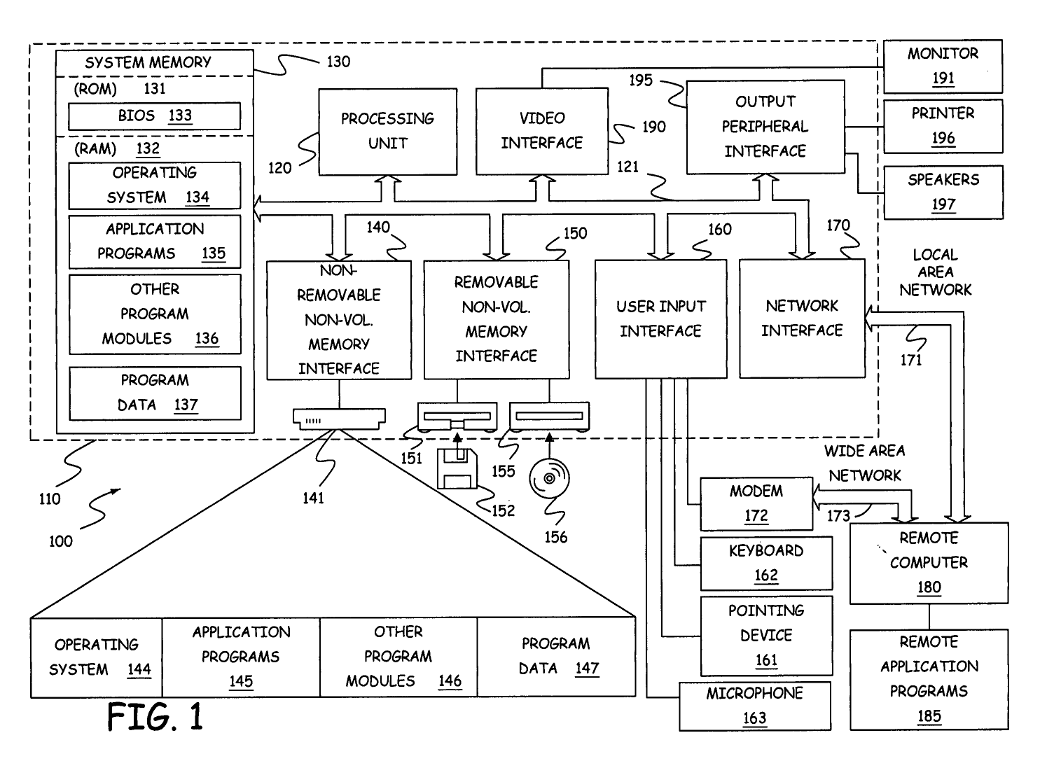

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. Tasks performed by the programs and modules are described below and with the aid of figures. Those skilled in the art can implement the description and figures as processor executable instructions, which can be written on any form of a computer readable medium.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

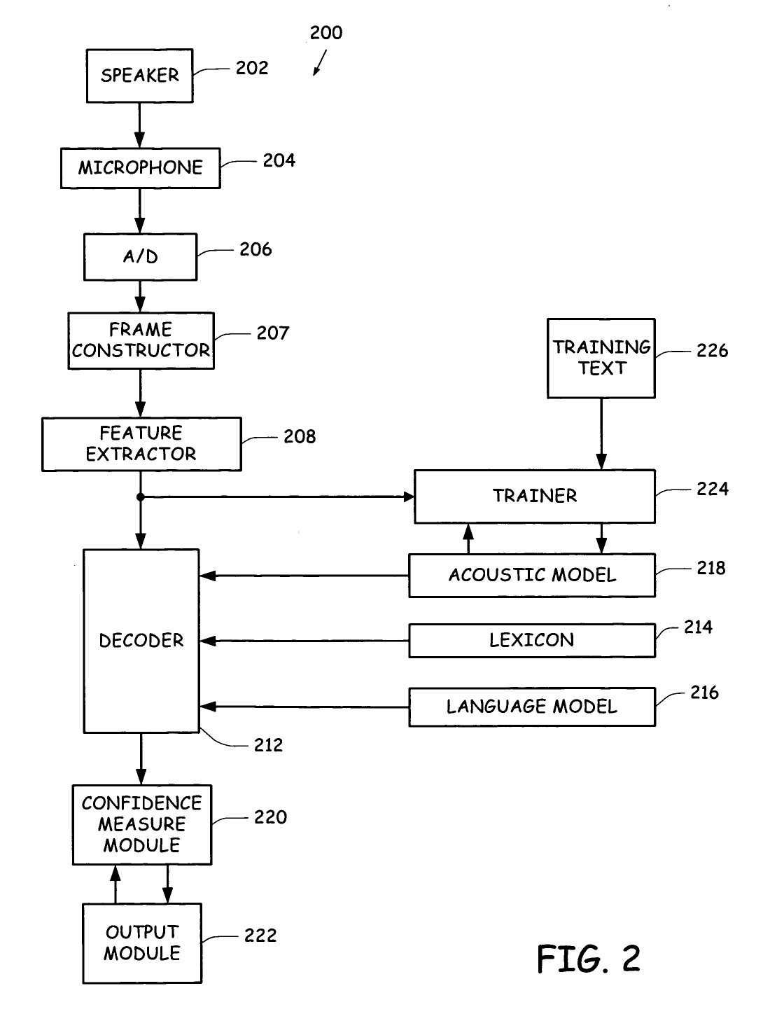

FIG. 2 provides a block diagram of a speech recognition system 200. In FIG. 2, a speaker 202, either a trainer or a user, speaks into a microphone 204. The audio signals detected by microphone 204 are converted into electrical signals that are provided to analog-to-digital converter 206.

A-to-D converter 206 converts the analog signal from microphone 204 into a series of digital values. In several embodiments, A-to-D converter 206 samples the analog signal at 16 kHz and 16 bits per sample, thereby creating 32 kilobytes of speech data per second. These digital values are provided to a frame constructor 207, which, in one embodiment, groups the values into 25 millisecond frames that start 10 milliseconds apart.

The frames of data created by frame constructor 207 are provided to feature extractor 208, which extracts a feature from each frame. Examples of feature extraction modules include modules for performing Linear Predictive Coding (LPC), LPC derived cepstrum, Perceptive Linear Prediction (PLP), auditory model feature extraction, and Mel-Frequency Cepstrum Coefficients (MFCC) feature extraction. Note that system 200 is not limited to these feature extraction modules and that other modules may be used within the context of system 200.

The feature extraction module 208 produces a stream of feature vectors that are each associated with a frame of the speech signal. This stream of feature vectors is provided to a decoder 212, which identifies a most likely sequence of words based on the stream of feature vectors, a lexicon 214, a language model 216 (for example, based on an N-gram, context-free grammars, or hybrids thereof), and an acoustic model 218.

The most probable sequence of hypothesis words is provided to a confidence measure module 220. Confidence measure module 220 identifies which words are most likely to have been improperly identified by the speech recognizer, based in part on a secondary acoustic model (not shown). Confidence measure module 220 then provides the sequence of hypothesis words to an output module 222 along with identifiers indicating which words may have been improperly identified. Those skilled in the art will recognize that confidence measure module 220 is not necessary for the operation of system 200.

During training, a speech signal corresponding to training text 226 is input to trainer 224, along with a lexical transcription of the training text 226. Trainer 224 trains acoustic model 218 based on the training inputs. Acoustic model 218 is intended to be one example implementation of a model. Other types of pattern recognition systems can utilize the subject matter described herein, namely handwriting recognition systems. WLR

Acoustic model 218 can be developed as a Weighted Likelihood Ratio (WLR) Hidden Markov Model (HMM). The model can be applied to various different languages. The WLR emphasizes spectral peaks and reduces emphasis on valleys when comparing two given speech spectra. A WLR measure is more consistent with human perception of speech formants where natural resonances of vocal track are and tend to be more robust to noise interferences than other measures where no emphasis is placed on the spectral peaks. In terms of local (in frequency) signal-to-noise ratio (SNR), peaks of a speech spectrum are less polluted by noises. Thus, a WLR HMM can include a high weight based on peaks of spectra and a low weight based on valleys of spectra. Alternatively, a particular spectrum, e.g. only linear spectrum from testing signal, can also be used to provide an asymmetric WLR measure. In standard WLR HMM, the linear spectrum difference between testing signal and referenced one is used as the weighting function.

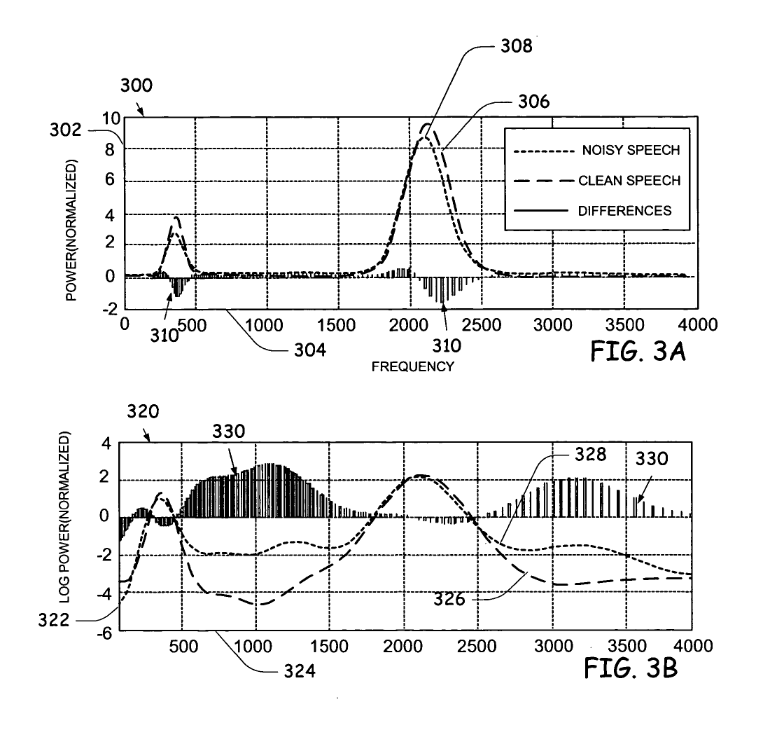

FIGS. 3A and 3B illustrate power versus frequency and log power versus frequency of different speech spectra. In FIG. 3A, graph 300 includes a power axis 302 and a frequency axis 304. Spectrum 306 represents clean speech, which is usually used to train model 218 using trainer 224 and spectrum 308 represents noisy speech that usually includes the testing spectrum to be recognized. Speech can be noisy in a variety of different situations and settings. For example, noise can be caused by background sounds such as a subway, babble, cars, etc. Bars 310 represent differences between spectra 306 and 308.

In FIG. 3B, graph 320 includes a log power axis 322 and a frequency axis 324. Spectrum 326 represents clean speech and spectrum 328 represents noisy speech. Bars 330 represent differences between spectra 326 and 328. Differences 330 show the distortion of spectrum 328 and spectrum 326 are mainly concentrated on the valley parts, which are easily affected by noises. Using WLR, which weights log spectral difference with corresponding linear spectral difference, the distortion can be reduced. Thus, valley parts can be de-emphasized and peak parts, which are more reliable, can be emphasized after introducing WLR.

WLR can be formulated using integrands, where log Sₜ(ω)−log Sᵣ(ω) is the difference between two log spectra: test spectrum log Sₜ(ω) and reference spectrum log Sᵣ(ω). Sₜ(ω)−Sᵣ(ω) is a difference between corresponding linear spectra and can be used as a weighting function. WLR distortion d_{wlr} can be expressed as:

$${d}_{wlr} \text{(} log {S}_{t} ( w ) , log ( {S}_{r} ( w ) ) = {\int }_{- π}^{π} [ ( {S}_{t} ( w ) - {S}_{r} ( w ) ] [ log {S}_{t} ( w ) - log {S}_{r} ( w ) ] \frac{ⅆ w}{2 π} \qquad EQ . 1$$

Parseval's theorem states that the sum (or integral) of the square of a function is equal to the sum (or integral) of the square of its transform. Thus, according to Parseval's theorem, WLR spectral distortion can be re-formulated as:

$${d}_{wlr} \text{(} log {S}_{t} ( w ) , log ( {S}_{r} ( w ) ) = {\sum }_{i = - ∞}^{+ ∞} [ ( {r}_{t} ( i ) - {r}_{r} ( i ) ) ( {c}_{t} ( i ) - {c}_{r} ( i ) ) ] \qquad EQ . 2$$

Here, rₜ(i) and cₜ(i) are autocorrelation and cepstral coefficients of the test spectrum, respectively. Similarly, rᵣ(i) and cᵣ(i) are autocorrelation and cepstral coefficients for the reference spectrum, respectively. Autocorrelation coefficients provide an indication of correlation between a signal and a time shifted version of the signal. It should be noted that the weighting function can satisfy equation 3 below. In other words, the 0th coefficients of rₜ(i) and rᵣ(i) are constrained to unity power, or 1.

$${\int }_{- π}^{π} {S}_{t} ( w ) \frac{ⅆ w}{2 π} = 1 \\ {\int }_{- π}^{π} {S}_{r} ( w ) \frac{ⅆ w}{2 π} = 1 \qquad EQ . 3$$

MFCC based WLR

In one example, cepstra used in equation 2 are used as MFCC, although other coefficients such as LPCC can be used. MFCCs are obtained by performing a Fourier transform on a spectrum and converting a resulting power spectrum obtained from the Fourier transform to a mel-frequency spectrum. The logarithm of the resulting spectrum is then obtained and an inverse Fourier transform is performed to obtain the coefficients. MFCC includes both static and dynamic features and in one example includes 13 coefficients for the static part. Static features can represent a particular interval of time (for example a frame) while dynamic features can represent the time changing attributes of a signal. Here, an arithmetical mean of MFCC can be used to approximate the centroids of the WLR-based measure. Given the MFCC, a corresponding weighting function can be derived with autocorrelation coefficients.

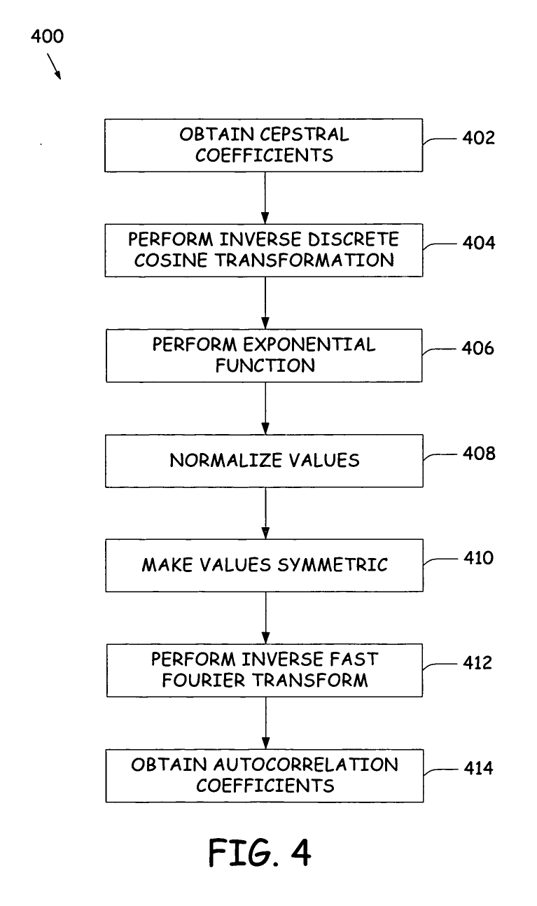

FIG. 4 is a flow diagram of a method of extracting a weighting function from MFCC. Method 400 begins at step 402 wherein cepstral coefficients are obtained. At step 404, an inverse discrete cosine transformation is performed and filter bank coefficients are obtained. At step 406, the exponential (e^{x}) function is performed from the transformation of step 404 and linear values for each filter bank are obtained. At step 408, the values are normalized and satisfied to equation 3 above. These values are then symmetrically extended at step 410 and an inverse fast Fourier transform is performed at step 412. From this transform, the autocorrelation coefficients that corresponded to normalized linear spectrum are obtained at step 414.

WLR-HMM

The WLR distortion discussed above can be applied to an HMM that includes a plurality of states and transitions between states. In one example, the states are represented as linguistic units such as phones or words.[cl] A probability density function (pdf) can be associated with each state. It can be shown that the WLR distortion values are nonnegative from equation 1 since the log function is monotonic and thus the difference of linear spectra has the same +/− sign as the corresponding parts of log spectra in the integrand. Thus, the integrand is semi-positive. A mixture of exponential kernels can be used to model the output pdf as shown in equation 4, and can be reffered to as WLR-HMM. In equation 4, bⱼ represents the pdf for the jth state in the model and k represents the component/mixture index

$${b}_{j} ( {o}_{t} ) = {\sum }_{k = 1}^{M} {W}_{jk} {β}_{jk} exp ( - {β}_{jk} * {d}_{wlr} ( {o}_{t} , {u}_{jk} ) ) \qquad EQ . 4$$

Here, oₜ, is the observation vector including rₜ(i) and cₜ(i) and μⱼₖ is the mean vector and βⱼₖ is the inverse mean of the WLR distortion of the j-th state and k-th component. Also Wⱼₖ is the weighing coefficient of the k-th component for the j-th state. The pdf can also be realized as in equation 5.

$${b}_{j} ( {o}_{t} ) = {max}_{k = 1 , 2 … M} \{ {β}_{jk} exp ( - {β}_{jk} * {d}_{wlr} ( {o}_{t} , {u}_{jk} ) ) \} \qquad EQ . 5$$

The auxiliary Q-function for WLR-HMM density can be written as:

$$Q ( \overline{θ} , θ ) = {\sum }_{q} P ( O , q \vert θ ) \cdot log P ( O , q \vert \overline{θ} ) \qquad EQ . 6$$

By taking the partial derivative of right side of equation 5 with regard to each parameter and let them equal to 0, the updated βⱼₖ, centroids and kernel weights can be derived and given as:

$${\overline{β}}_{jk} = \frac{{\sum }_{t = 1}^{T} {Ψ}_{jk} ( t )}{{\sum }_{t = 1}^{T} {ψ}_{jk} ( t ) \cdot {d}_{wlr} ( {o}_{t} , {u}_{jk} )} \\ {\overline{u}}_{jk} = \frac{{\sum }_{t = 1}^{T} {ψ}_{jk} ( t ) \cdot {o}_{t}}{{\sum }_{t = 1}^{T} {ψ}_{jk} ( t )} \\ {\overline{w}}_{jk} = \frac{{\sum }_{t = 1}^{T} {Ψ}_{jk} ( t )}{{\sum }_{k = 1}^{M} {\sum }_{t = 1}^{T} {ψ}_{jk} ( t )} \qquad EQ . 7 \text{-} 9$$

Where, Ψⱼₖ(t) is an indicator function which is 1 if oₜ is associated with the k-th component of the j-th state and is zero otherwise.
2-stream WLR-HMM

Dynamic cepstral features can play a more important role, especially for noisy speech recognition. As discussed above, WLR-HMM can help improve the noise robustness of static MFCC by more robust distortion measure. The static features and dynamic features can be merged. Using equation 10, the features can be integrated by two-stream when computing the likelihood scores. Weighting coefficients γ¹ and γ² are used to reflect the relative importance and normalize the different dynamic ranges of scores from these two streams.

$${b}_{j} ( {o}_{t} ) = {[ {\sum }_{k = 1}^{M} {w}_{jk} {β}_{jk} exp ( - {β}_{jk} * {d}_{wlr} ( {o}_{t}^{wlr} , {u}_{jk}^{wlr} ) ) ]}^{γ 1} * {[ {\sum }_{k = 1}^{M} {c}_{jk} N ( {o}_{t}^{d} ; {u}_{jk}^{d} , {\sum }_{jk}^{d} ) ]}^{γ 2} \qquad EQ . 10$$

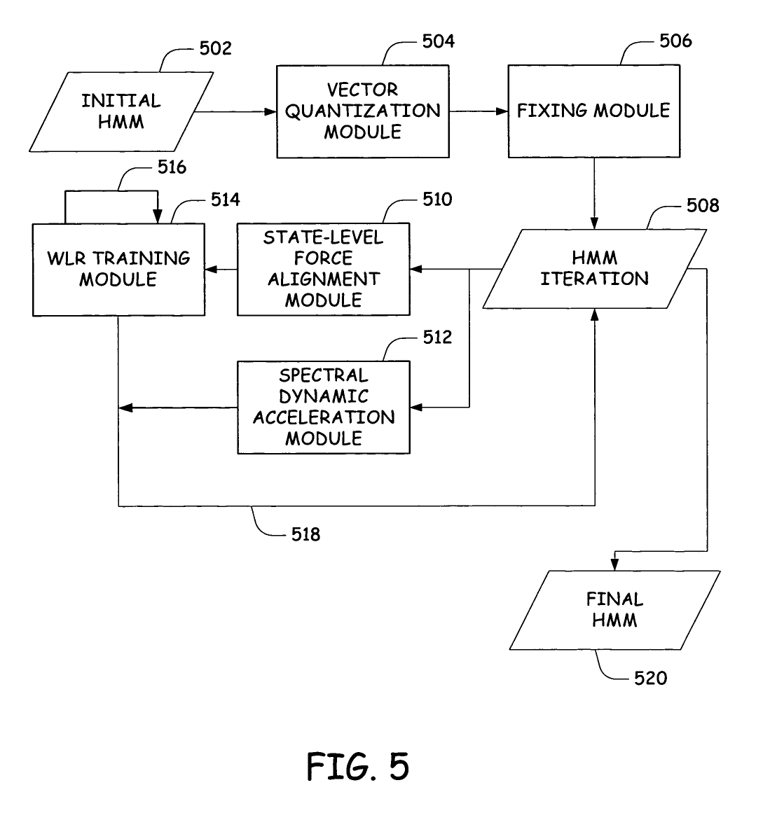

FIG. 5 is a diagram of components used for training a two-stream WLR-HMM. A tool kit such as the Hidden Markov Model Tool Kit (HTK), available at HTTP://htk.eng.cam.ac.uk, can be used as starting points to develop the model. Based on HTK, two-stream WLR-HMM training and decoding tools have been newly developed. An initial Hidden Markov Model 502 is used to begin training a two-stream WLR HMM. Vector quantization module 504 can be used to initialize the mean vector of HMM 502. Fixing module 506 can be used to fix variables so as to be compatible with the data structure of a tool kit, for example the HTK. An HMM iteration 508 is then used. Iteration 508 is a model that can be then processed using a two-stream process. A state-level force alignment module 510 is used to align observations into a state level according to a model from iteration 508, which includes two-stream. A spectral dynamic acceleration module 512 is used to train dynamic features of HMM iteration 508. According to output from module 510, WLR training module 514 is then used to train a probability density function based on equations 7-9 discussed above. An internal loop 516 is used to iteratively train functions for a new Hidden Markov Model. The model resulting from WLR training module 514 is combined with results from the spectral dynamic acceleration module 512 to form a new Hidden Markov Model iteration 508. An external loop 518 is created for multiple iterations. After a number of iterations, a final Hidden Markov Model 520 is output.

A HMM framework based on WLR measure, called WLR-HMM, can be used as an acoustic model for a speech recognition system as discussed above. After combining with dynamic cepstral features, a multiple stream WLR-HMM can improve performance in noisy situations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of developing a pattern recognition model comprising:
accessing a reference spectrum defined by a plurality of reference coefficients;
accessing a test spectrum defined by a plurality of test coefficients;
comparing the reference spectrum coefficients and the test spectrum coefficients; and
deriving a weighted model defined by a plurality of weighted coefficients based on the comparison.

2. The method of claim 1 wherein comparing comprises finding a difference in power between the reference spectrum and the test spectrum.

3. The method of claim 1 wherein comparing comprises finding a difference in log power between the reference spectrum and the test spectrum.

4. The method of claim 1 wherein the weighted coefficients include high weights based on peaks in the reference spectrum and test spectrum.

5. The method of claim 1 wherein the weighted coefficients include low weights based on valleys in the reference spectrum and test spectrum.

6. The method of claim 1 wherein the weighted coefficients correspond to autocorrelation coefficients derived from Mel frequency cepstral coefficients.

7. The method of claim 1 wherein the reference or test spectrum coefficients correspond to Mel frequency cepstral coefficients or linear prediction cepstral coefficients.

8. A speech recognizer, comprising:
an acoustic model adapted to generate a plurality of possible sequences of hypothesized linguistic units for a speech signal, the units including associated probability density functions, each probability density function including a weighted coefficient derived from a comparison of spectra; and
a decoder coupled to the acoustic model and adapted to select a best possible sequence of units based on the probability density functions and the speech signal.

9. The speech recognizer of claim 8 wherein the acoustic model includes static feature components and dynamic feature components adapted to model static features and dynamic features of the speech signal, respectively.

10. The speech recognizer of claim 9 wherein the static feature components include weighting coefficients different from weighting coefficients for the dynamic feature components.

11. The speech recognizer of claim 8 wherein the acoustic model is adapted to provide a high weight to a peak in the speech signal and a low weight to a valley in the speech signal.

12. The speech recognizer of claim 8 and further comprising a feature extraction module adapted to extract features from the speech signal.

13. The speech recognizer of claim 12 wherein the feature extraction module is adapted to perform Mel frequency cepstrum coefficients feature extraction.

14. A method of training a pattern recognition model, comprising:
accessing a first model defined by a plurality of states, each state having an associated probability density function;
identifying a distortion measure from a comparison of spectra; and
forming a second model from the first model and the distortion measure, the second model defined by a plurality of states, each state having an associated probability density function based on the distortion measure.

15. The method of claim 14 wherein the distortion measure is based on a difference between a reference spectrum and a test spectrum.

16. The method of claim 14 wherein the second model is defined by a plurality of cepstral coefficients and autocorrelation coefficients derived from the cepstral coefficients.

17. The method of claim 14 wherein the distortion measure is based on a comparison of power spectra.

18. The method of claim 14 wherein the distortion measure is based on a comparison of log power spectra.

19. The method of claim 14 wherein each probability density function includes a static component and a dynamic component.

20. The method of claim 19 wherein the static component includes a first weight and the dynamic component includes a second weight different from the first weight.
